(19) United States
(12) Patent Application Publication
(10) Pub. No.: US 2024/0319404 A1
(43) Pub. Date: Sep. 26, 2024

(54) Petrophysical Modeling of a Subterranean Formation

(71) Applicant: Saudi Arabian Oil Company, Dhahran (SA)

(72) Inventors: Nerio Jose Quintero Tudares, Al Khobar (SA); Fatima Alkaba, Dhahran (SA); Christon Achong, Dhahran (SA); Majed Fareed Kanfar, Dammam (SA)

(21) Appl. No.: 18/187,472

(22) Filed: Mar. 21, 2023

(51) Int. Cl. G01V 99/00

(52) U.S. Cl. CPC G01V 20/00

(57) ABSTRACT

Methods and systems for petrophysical modeling of a subterranean reservoir include generating a first distribution of values representing a fluid volume and a second distribution of values representing a mineral volume of the subterranean formation, the generating being based on a probabilistic mineralogical evaluation; determining a third distribution of values representing a volume of silt distribution in the subterranean formation; and generating a model specifying a predicted permeability distribution for the subterranean formation, the model being based on the first distribution of values representing the fluid volume, the second distribution of values representing the mineral volume, and the third distribution of values representing the volume of silt.

### TECHNICAL FIELD

The present disclosure generally relates to hydrocarbon exploration. More specifically, the present disclosure relates to petrophysical modeling of a subterranean formation.

### BACKGROUND

In some subterranean formations, such as tight gas clastic reservoirs, core data can exhibit high heterogeneity for critical petrophysical rock parameters, such as permeability. High heterogeneity of properties of a subterranean formation can produce large uncertainties if the heterogeneity is masked due to insufficient log resolution. Permeability can be used for petrophysical rock typing, and high uncertainties can result in incorrect determinations of rock types which can adversely affect estimations of water saturation and hydrocarbon reserves.

### SUMMARY

This specification describes systems and methods for enhancing petrophysical modeling of subterranean formations. A data processing system is configured for acquiring data from core samples and well logs, determining a distribution of a volume of silt for the formation based on the data from core samples and well logs and generating a model specifying a distribution of predicted permeability of the formation using a clustering analysis. A data processing system, based on the predicted permeability values, determines petrophysical rock types and water saturation levels in the subterranean formations.

The processes and systems enable on or more of the following technical advantages. The data processing system enables identification of heterogeneities in a subsurface formation that are not identified using only well log data. The data processing system takes as input more data than conventional methods to determine permeability of a subsurface formation. For example, the data processing system uses density and neutron logging data to determine a volume of silt in addition to the well log data used in conventional methods. The data processing system does not rely on assumptions of homogeneity of the subsurface formation.

One or more of these advantages are enabled by one or more of the following embodiments.

In one aspect, a method for petrophysical modeling of a subterranean reservoir includes generating a first distribution of values representing a fluid volume and a second distribution of values representing a mineral volume of the subterranean formation, the generating being based on a probabilistic mineralogical evaluation; determining a third distribution of values representing a volume of silt distribution in the subterranean formation; and generating a model specifying a predicted permeability distribution for the subterranean formation, the model being based on the first distribution of values representing the fluid volume, the second distribution of values representing the mineral volume, and the third distribution of values representing the volume of silt.

In one aspect, one or more non-transitory machine-readable storage devices storing instructions for petrophysical modeling of a subterranean reservoir, the instructions being executable by one or more processing devices to cause performance of operations including generating a first distribution of values representing a fluid volume and a second distribution of values representing a mineral volume of the subterranean formation, the generating being based on a probabilistic mineralogical evaluation; determining a third distribution of values representing a volume of silt distribution in the subterranean formation; and generating a model specifying a predicted permeability distribution for the subterranean formation, the model being based on the first distribution of values representing the fluid volume, the second distribution of values representing the mineral volume, and the third distribution of values representing the volume of silt.

In one aspect, a system for petrophysical modeling of a subterranean formation includes at least one processor; and a memory storing instructions that, when executed by the at least one processor, cause the at least one processor to perform operations including generating a first distribution of values representing a fluid volume and a second distribution of values representing a mineral volume of the subterranean formation, the generating being based on a probabilistic mineralogical evaluation; determining a third distribution of values representing a volume of silt distribution in the subterranean formation; and generating a model specifying a predicted permeability distribution for the subterranean formation, the model being based on the first distribution of values representing the fluid volume, the second distribution of values representing the mineral volume, and the third distribution of values representing the volume of silt.

Embodiments of these aspects may include one or more of the following features.

In some embodiments, these aspects include defining, based on the model, distinct petrophysical rock types for the subterranean formation.

In some embodiments, these aspects include generating, based on the predicted permeability distribution and the defined petrophysical rock types, a saturation height function model specifying the saturation of fluids in the subterranean formation.

In some cases, these aspects further include estimating, based on the predicted permeability distribution, the defined petrophysical rock types and the saturation height function model, hydrocarbon reserves in the subterranean formation.

In some embodiments, determining the volume of silt distribution comprises processing data from Thomas Stieber plots and a deterministic shaly silt sand model.

In some embodiments, generating a model specifying a predicted permeability comprises clustering values from a set of log predictors.

In some embodiments, clustering values comprises a machine learning model clustering values from a set of log predictors.

In some embodiments, these aspects further include classifying, based on the model, electrofacies of the subterranean formation, wherein classes of electrofacies correspond with ranges of predicted permeability.

In some embodiments, these aspects include controlling production of hydrocarbons from the subterranean formation based on the predicted permeability.

In some embodiments, these aspects include validating the predicted permeability distribution based on comparing the predicted permeability to measured core data.

In some embodiments, the probabilistic mineralogical evaluation includes generating forward modeled distributions of values representing fluid and mineral volumes; generating a set of logs based on the forward modeled distributions representative of measured well logs; and refining the forward modeled distributions by minimizing an error between the generated set of logs and the measured well logs.

The details of one or more embodiments of these systems and methods are set forth in the accompanying drawings and the description to be presented. Other features, objects, and advantages of these systems and methods will be apparent from the description and drawings, and from the claims.

### DESCRIPTION OF DRAWINGS

FIG. 1 is a schematic illustrating a well logging operation.

FIG. 2 is a flow chart of an example method of predicting permeability in a subsurface formation.

FIG. 3 is a flow chart of an example method of predicting permeability in a subsurface formation.

FIG. 4 shows matrix correlation and error measured in training and blind test sets for an example reservoir.

FIG. 5A shows matrix correlation and error measured in training and blind test sets for an example reservoir.

FIG. 5B shows a cross plot of measured permeability versus predicted permeability.

FIG. 6 is a block diagram illustrating an example computer system used to provide computational functionalities associated with described algorithms, methods, functions, processes, flows, and procedures as described in the present disclosure, according to some implementations of the present disclosure.

Like reference symbols in the various drawings indicate like elements.

### DETAILED DESCRIPTION

This specification describes systems and methods for enhancing petrophysical modeling of subterranean formations. A data processing system is configured to acquire data from core samples and well logs. The data processing system applies a probabilistic mineralogical evaluation to the acquired data to determine a distribution of values representing a fluid volume of the subterranean formation and a distribution of values representing a mineral volume of the subterranean formation. Based on the acquired data, the data processing system also determines a distribution of values representing a volume of silt of the formation. The data processing system generates a model, based on the distributions of the fluid volume, mineral volume, and volume of silt, specifying a distribution of predicted permeability of the formation using a clustering analysis. Based on the distribution of predicted permeability, the data processing system estimates hydrocarbon reserves of the subterranean formation.

Well logs include records of geologic formations penetrated by a borehole. They include data such as measurements of electrical resistivity, porosity, or gamma ray irradiation. Wireline logging provides a record over a period of time describing a formation's rock properties. Wireline logging includes performing measurements of formation properties and associating the measurements with a distance value specifying a location in the wellbore in which the measurements are made. A data processing system described herein analyzes wireline log data. From the wireline log data, the data processing system determines formation properties including hydrocarbon saturation and formation pressure. The data processing system generates a recommendation for drilling and production locations based on the analysis of the determined formation properties. The data processing system can send the recommendation to other computing systems for controlling drilling operations, render the recommendation on a user interface, and so forth.

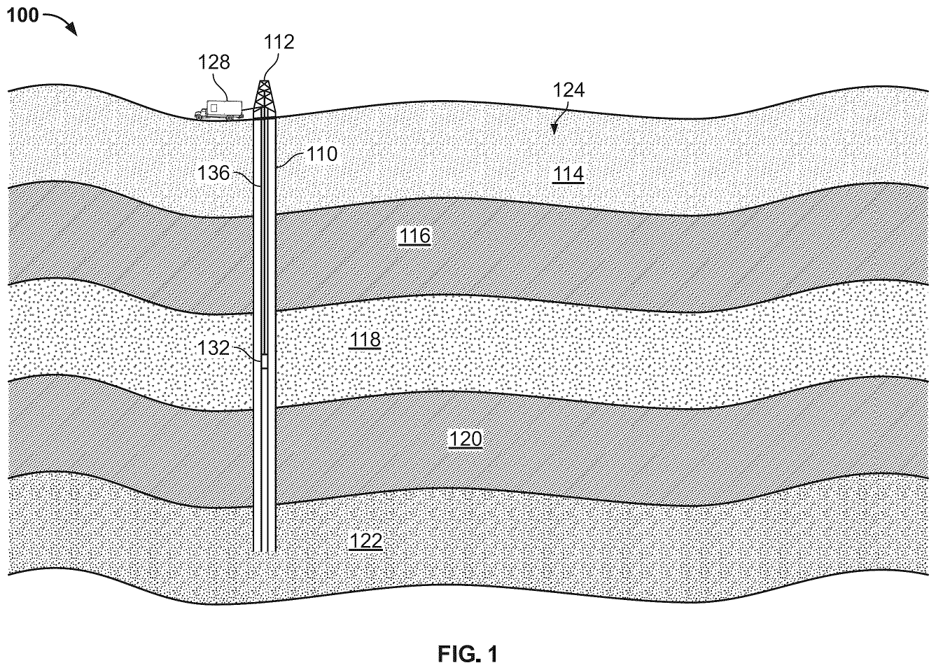

FIG. 1 illustrates a well logging operation 100 in which a wellbore 110 extends downhole from a wellhead 112. The wellbore 110 is a vertical wellbore but well logging can also be performed in other wellbores, for example, slanted or horizontal wellbores. In the well logging operation 100, the wellbore 110 penetrates through five layers 114, 116, 118, 120, 122 of a subterranean formation 124. A control truck 128 lowers a logging tool 132 down the wellbore 110 on a wireline 136.

The logging tool 132 is string of one or more instruments with sensors operable to measure petrophysical properties of the subterranean formation 124. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which typically a function of lithology and rock texture but particularly porosity. The logging tool consists of a piezoelectric transmitter and receiver and the time taken for the sound wave to travel the fixed distance between the two is recorded as an interval transit time.

As the logging tool 132 travels downhole, measurements of formations properties are recorded to generate a well log. In the illustrated operation, the data are recorded at the control truck 128 in real-time. Real-time data are recorded directly against measured cable depth. In some well-logging operations, the data is recorded at the logging tool 132 and downloaded later. In this approach, the downhole data and depth data are both recorded against time The two data sets are then merged using the common time base to create an instrument response versus depth log.

In the well logging operation 100, the well logging is performed on a wellbore 110 that has already been drilled. In some operations, well logging is performed in the form of logging while drilling techniques. In these techniques, the sensors are integrated into the drill string and the measurements are made in real-time, during drilled rather using sensors lowered into a well after drilling.

For some wells, core samples can be obtained in addition to obtaining well logs. A core sample is a usually cylindrical piece of the subterranean formation that is removed by a special drill and brought to the surface. Core samples can be used to measure petrophysical properties of the subterranean formation such as grain size, porosity, and permeability. Core samples can be taken from the sidewalls of a drilled well. When sidewall core samples are repeated along the length of the well, the properties measured from the core samples can be compared and correlated with well logging measurements.

Within tight gas clastic reservoirs, core data can exhibit high heterogeneity for critical petrophysical rock parameters, such as permeability. Permeability variations can be observed to change over several logarithmic cycles, without any apparent change on the well log signature across the interval. Using standard modeling workflows for uncored wells can produce large uncertainties associated with the masked heterogeneity due to resolution differences of the well logs. Permeability can be used for petrophysical rock typing and water saturation estimations.

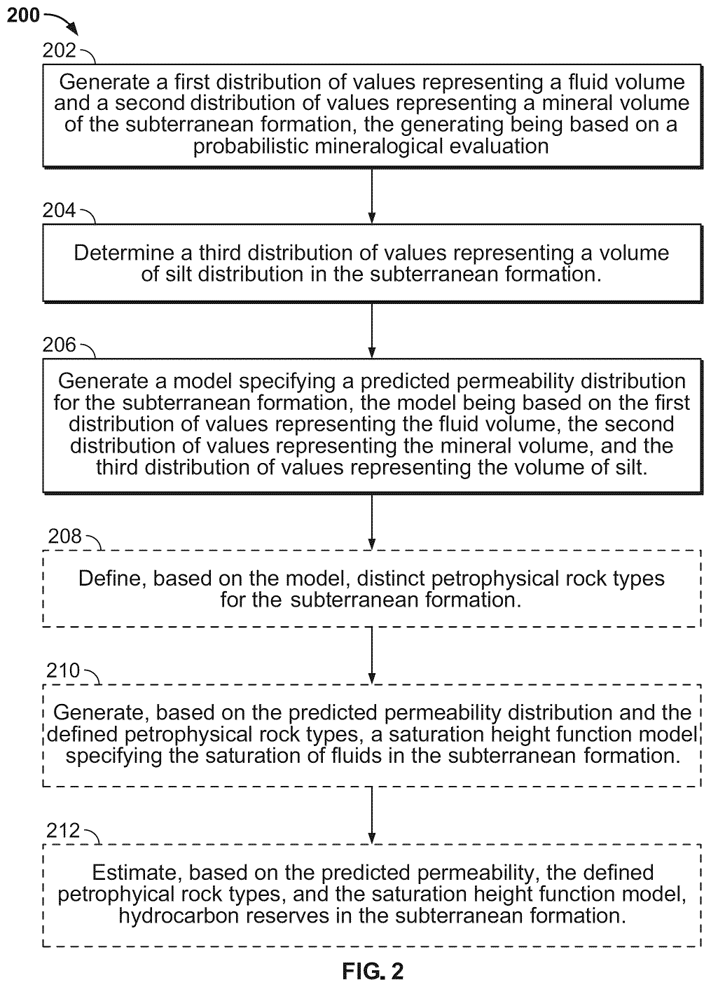

FIG. 2 shows a flow chart of an example method 200 to predict the permeability of a subsurface formation. The data processing system generates a distribution representing a fluid volume and a distribution representing a mineral volume of the subterranean formation by performing a probabilistic mineralogical evaluation of well log data and core sample data (step 202). The probabilistic mineralogical evaluation processes input data that is generated through geophysical exploration methods. The input data include core samples, mineralogical well logs, shaly silt sandstone logs, and lithofacies logs. For example, the data processing system forward models mineral and fluid volumes to generate a series of logs corresponding to logs that were acquired during a drilling process. The data processing system refines the forward modeled mineral and fluid volumes by minimizing least squares error between the forward modeled logs and the input logs to generate estimates of the mineral volumes and the fluid volumes in the subsurface.

The data processing system defines a distribution of values representing a volume of silt, Vₛᵢₗₜ, of the formation (step 204). In some implementations, the data processing system defines the distribution of the volume of silt by processing data from Thomas Stieber plots and a deterministic shaly silt sand model. For example, a silt volume occurring within glacial sandstone deposits is predominantly laminar in nature, the data processing system applies the Thomas-Stieber Model (Thomas & Stieber, 1975), which is a petrophysical model for laminated sand packages with density-neutron-gamma ray data. The data processing system generates, based on the model, properties of the subsurface formation such as net sand thicknesses and clean sand lamination porosities. The data processing system can solve for the laminated volume of silt within the area of investigation by selecting end points for model parameters such as sand total porosity, silt total porosity, and gamma ray values.

High volumes of silt in a subterranean formation can reduce permeability, due to poorly sorted grains adversely affecting pore network geometry. Variations in the volume of silt can account for heterogeneities that exist within thick amalgamated sand packages that are masked by log resolution and apparent clean sand proportions observed from core sample data. Tight formations can have a high average porosity value; however, there can be significant permeability changes throughout the formation. In some cases, the permeability can change every half foot, and in some cases, the permeability can change by more than several logarithmic decades. The volume of silt distribution has a high correlation with the permeability and accounts for such changes.

The data processing system generates a model, based on the distributions representing the fluid volume, the mineral volume, and the volume of silt, specifying a distribution of predicted permeability (step 206). The data processing system performs a significance test on the input well logs and core sample data to generate a unique correlation matrix to select the best log predictors. For example, the data processing system performs a significance test on a large number of input logs to determine which logs are useful and relevant for predicting permeability. The number of logs selected depends on the output of the significance test and model development and training time.

In some implementations, the significance test includes a supervised classification through clustering (e.g., k nearest neighbors (KNN) and Gaussian mixture). The data processing system evaluates the relationship between each log predictor and the target variable (e.g., core permeability) during the training phase of classification or regression models. The data processing system selects the best ranked predictor based on correlation factor, accuracy value and the difference between mean squared error from the test set and the training set.

The data processing systems performs a clustering analysis on the log predictors having a correlation factor, accuracy, and mean squared error difference above or below a threshold value to generate the distribution of predicted permeability. For example, a log can be selected for the clustering analysis if the correlation factor is greater than 50%, the accuracy value is greater than 65%, and if the difference between mean squared error from the training set and the test set is less than 0.25.

The data processing system can use a machine learning model to perform the clustering analysis. For example, the data processing system can use a machine learning model including a neural network, a random forest, a convolutional neural network, a multiple linear regression, a support vector regression, or a decision tree. The data processing system obtains the training data from the log data selected in the significance test. These data have been previously cleaned by, for example, applying proper environmental corrections, proper minimum & maximum limits, and converting to proper units.

In some implementations, the data processing system performs a multi-resolution graphic clustering (MRGC) analysis to generate the distribution of predicted permeability. The MRGC analysis includes the selected input logs based on a significance test. The MRCG analysis includes labeling the selected logs as the best log predictors. For example, the data processing system, based on the MRGC analysis, may select a log that specifies a volume of silt. The data processing system, based on the MRGC analysis is able to discern the heterogeneity of the subterranean formation when generating the values of the predicted permeability. In some implementations, the data processing system matches the predicted permeability to the measured data inside one standard deviation. Using the MRGC analysis, the data processing system generates a set of clusters representative of unique fingerprints in the best log predictors corresponding to fingerprints of core permeability at specific depths. In depth intervals without core permeability measurements, the measurement of each log input are compared with the fingerprint associated with each cluster, the input data is assigned to one cluster, and the permeability value of that cluster is assigned for to the depth interval.

In an aspect, the data processing system evaluates a permeability prediction by comparing a predicted permeability distribution that includes a distribution of volume of silt as one of the log predictors with a predicted permeability distribution that does not include a distribution of volume of silt as one of the log predictors. A viable permeability model can have a correlation factor above 74% (between core data and predicted data). In uncored wells, the predicted data can capture the general trend of dynamic data (e.g., permeability from pressure transient analysis) with a maximum difference ratio 1:10, to be considered good.

The data processing system validates the predicted permeability by computing an R² value between the predicted permeability and a permeability measured from core samples taken from the subterranean formation. The data processing system generates models that produce R² values exceeding 78% which demonstrates that the model is viable to estimate hydrocarbon reserves. In some implementations, the data processing system performs additional blind testing to assess model viability using, for example, permeability data, mobility data, formation test data, production data, production logs, fluid sampling, etc. If pressure data and mobility data are available from formation testing, a permeability value may be estimated, and used as a guide. For example, if the formation testing indicates a high permeability, the predicted permeability should tend to high values and vice versa.

In some implementations, the data processing system classifies, based on the predicted permeability, electrofacies of the subterranean formation. Electrofacies are clusters with specific log signatures correlated to a target variable. The data processing system generates electrofacies clusters based on log signatures associated with permeability values in the predicted permeability.

In some implementations, the data processing system defines distinct petrophysical rock types based on the permeability prediction (step 208). In some cases, the data processing system compares the petrophysical rock types defined based on the permeability prediction with petrophysical rock types determined from mercury injection capillary pressure (MICP) data. The data processing system improves an accuracy of classification by incorporating permeability heterogeneities specific to petrophysical rock types. For example, the data processing system generates a model from the effective pore throat sizes defined directly from MICP analysis. MICP analysis includes laboratory tests where a core plug is injected with mercury at high pressure. The results of this test are a table of capillarity pressure and volume of mercury injected, from which the data processing system calculates pore throat size along with other variables.

The data processing system generates, based on the predicted permeability and petrophysical rock types, a unique saturation height function for the subterranean formation (step 210). For example, each petrophysical rock type has a group of capillary pressure curves. The data processing system generates a saturation height function based on a fitting of variables including pore throat size, capillary pressure curves, and predicted permeability.

In some implementations, the data processing system validates a final saturation height function (SHF) model by comparing the SHF model with a resistivity-based water saturation estimate above an established free water level (FWL) utilizing FWL iterations to define the proper surface across the reservoir. FWL is an input received from reservoir analysis using production and/or formation data to define the fluids distribution in the subsurface formation. FWL defines the deepest depth of water production. The resistivity based saturation estimate represents the volume of water in the formation at the time of the well logging. The water saturation calculated from MICP data (e.g., SHF) represents a volume of water in the subsurface formation at the original conditions (e.g., original water in place before the field starts producing). The data processing system compares the resistivity based water saturation estimate and the SHF up to FWL. The SHF is calibrated to match the resistivity based saturation estimate to minimize the difference between the two. The data processing calibrates the SHF under specific criteria. For example, the FWL is validated by production or formation test; the borehole is in good condition; there are no abnormalities with the resistivity log; the subsurface formation has enough petrophysical rock types defined; the predicted permeability is crosschecked with dynamic data; and the calibration of the SHF is within one standard deviation from the mean of the petrophysical rock type capillarity curves. If the criteria are not satisfied, the data processing system uses the SHF to overrule the resistivity based water saturation estimate.

In some implementations, the data processing system estimates hydrocarbon reserves based on the predicted permeability, the petrophysical rock types, and the saturation height function models (step 212). Permeability has a direct impact on the reserves estimation. The data processing system uses the SHF to define the pay zone where hydrocarbons can be produced. In some implementations, the data processing system can generate control signals to control a drilling system based on the predicted permeability to produce hydrocarbons from the subterranean formation.

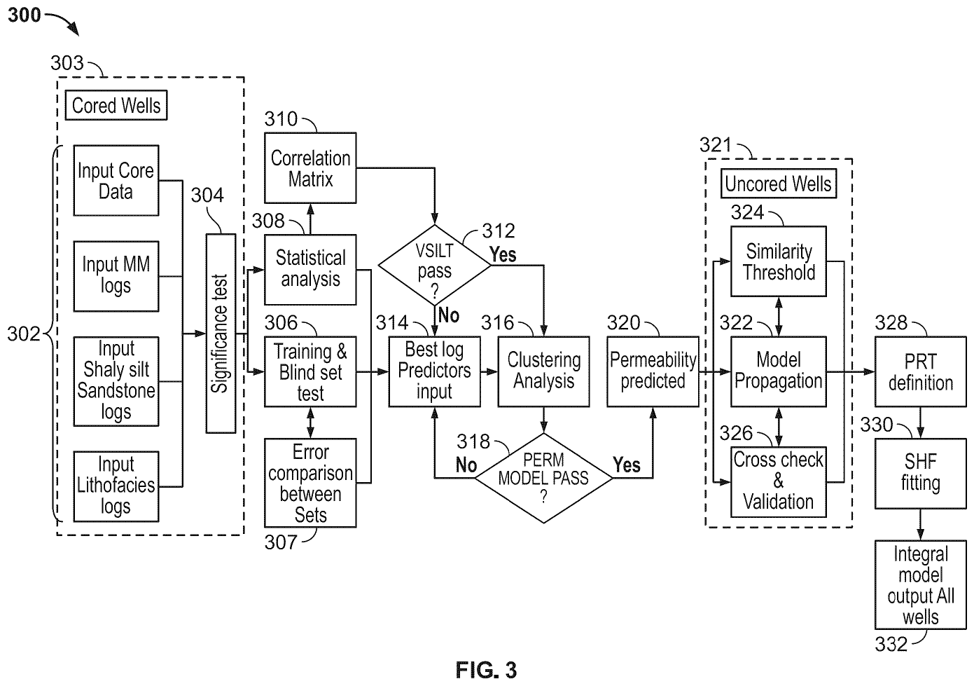

FIG. 3 shows a flow chart for an example method 300 for predicting a permeability for a subterranean formation. The data processing system receives (302) input data 303 from wells associated with core samples. Input data can include mineralogical logs, core sample data, shaly silt sandstone logs, lithofacies logs, and volume of silt. The data processing system performs (304) a significance test on the input data. The data processing system splits data from logs that pass the significance test into a training set and a blind set (306). For example, the training set is constructed with 80% of the input data (e.g., by random selection) and the testing set includes 20% of the input data. A difference between the training set and test set can be less than 20% for a correlation factor and less than 0.25 for a mean square error. The data processing system performs a statistical analysis on logs that pass the significance test to form fluid and mineral volumes (308). The data processing system generates a correlation matrix by correlating the fluid and mineral volumes with measured permeability from core samples (310). The data processing system eliminates logs with correlation factors less than 50% from the model training. If all logs have a correlation factor greater than 50%, the data processing system checks other metrics including an accuracy greater than 65% and an MSE difference less than 0.25 on the model training sets and test sets including all of the logs. The data processing system can iteratively check the model performance against threshold metrics leaving out a log predictor with the lowest correlation factor until a minimum of 4 log input log predictors are selected. The set of log predictors with the highest rank is selected for the clustering analysis with MRGC for permeability prediction.

The data processing system selects, based on the statistical analysis, the best log predictors (314). The data processing system performs a clustering analysis on the best log predictors (316). In some implementations, the data processing system uses a machine learning model to perform the clustering analysis. The data processing system performs a correlation test on the output of the clustering analysis (318). For example, the data processing system generates an XY cross plot comparing the core permeability against the predicted permeability. If the output of the clustering analysis correlates with the measured permeability from core samples with a correlation factor greater than a threshold value (e.g., 75%) the permeability prediction is complete (320). If the output of the clustering analysis is below the threshold correlation factor, the data processing system includes additional log predictors in the clustering analysis and recomputes the output.

The data processing system propagates (322) the clustering analysis model trained on data from cored wells from a subterranean formation to process input data from uncored wells 321 from the same formation. Selected log predictors from uncored wells including volume of silt are input into the clustering analysis that has been trained to cluster values in the log predictors based on the defined fingerprints corresponding to permeability for each cluster. In depth intervals without core permeability measurements, the measurement of each log input is compared with the fingerprint associated with each cluster, the input data is assigned to one cluster, and the permeability value of that cluster is assigned for to the depth interval. The output will be a permeability curve predicted on each well.

The data processing system applies a similarity threshold between the uncored well and the cored wells from the training set (324). The similarity threshold is a desired lower limit for the similarity of two data records that belong to the same cluster. For example, with a similarity threshold of 0.25, data records with field values that are less than 25% similar are unlikely to be assigned to the same cluster. The data processing system validates the predicted permeability by comparing with a measured permeability (326). For example, the data processing system validates predicted permeability from cored wells core permeability data. The data processing system validates predicted permeability from uncored wells with formation test data. In wells without any formation test, the data processing system can crosscheck the predicted permeability with predictions from a static 3D model, which populates properties between wells.

The data processing system determines petrophyhsical rock types for each well for which it predicted a permeability (328), and the data processing system generates a saturation height function model based on the predicted permeability and the petrophysical rock type (330). The data processing system integrates the predicted and determined properties from all wells considered for the formation to generate a petrophysical model for the subterranean formation (332).

Example implementations of the method 200 were tested for two example reservoirs in two different subterranean formations. Input logs included lithofacies logs from the reservoirs and distributions representing volume of silt defined by the data processing system. To optimize the number of input logs, the training and blind test errors were compared in terms of root-mean-square-error (RMSE), mean average error (MAE), and correlation factor for the best log predictor. The data processing system selected logs better correlated (e.g., high correlation factor) with the permeability measured from core samples for the clustering analysis.

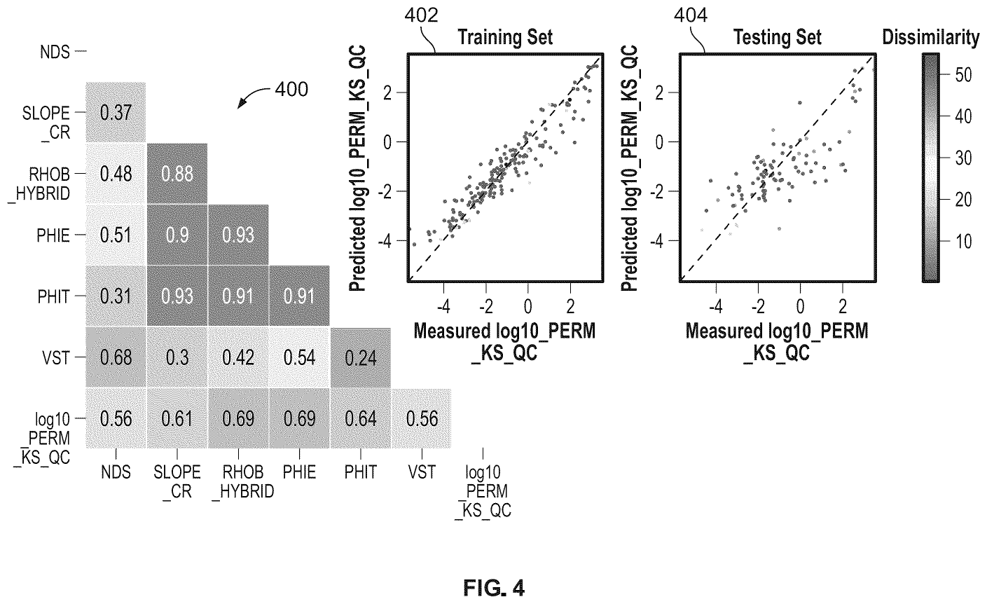

FIG. 4 shows a correlation matrix 400 and error plots for error measured for the training set 402 and error measured for the testing set 404 for Reservoir A. The error plots show predicted permeability versus permeability measured from core samples. When the correlation factor is higher than 76%, a direct relationship within one standard deviation of the measured values is expected. In this case, the R² value for the training set is 90.3%, and the R² value for the testing set is 58.3%. The RMSE for the training set is 0.582 and for the test set is 1.17. The MAE for the training set is 0.414 and for the test set is 0.905. Acronyms in FIG. 4 are defined as follows: Total porosity (PHIT); Density log (RHOB); Effective porosity (PHIE); Neutron porosity Log (NPL); Electrofacie (EFAC), logarithm 10 based of the core permeability corrected (Log 10_PERM_KS), Acoustic slope smoothed (SLOPE_CR_SM); Neutron density separation (NDS); Hybrid density log corrected by badhole flag (RHOB_HYBRID); Volume of silt (VST and/or VSILT).

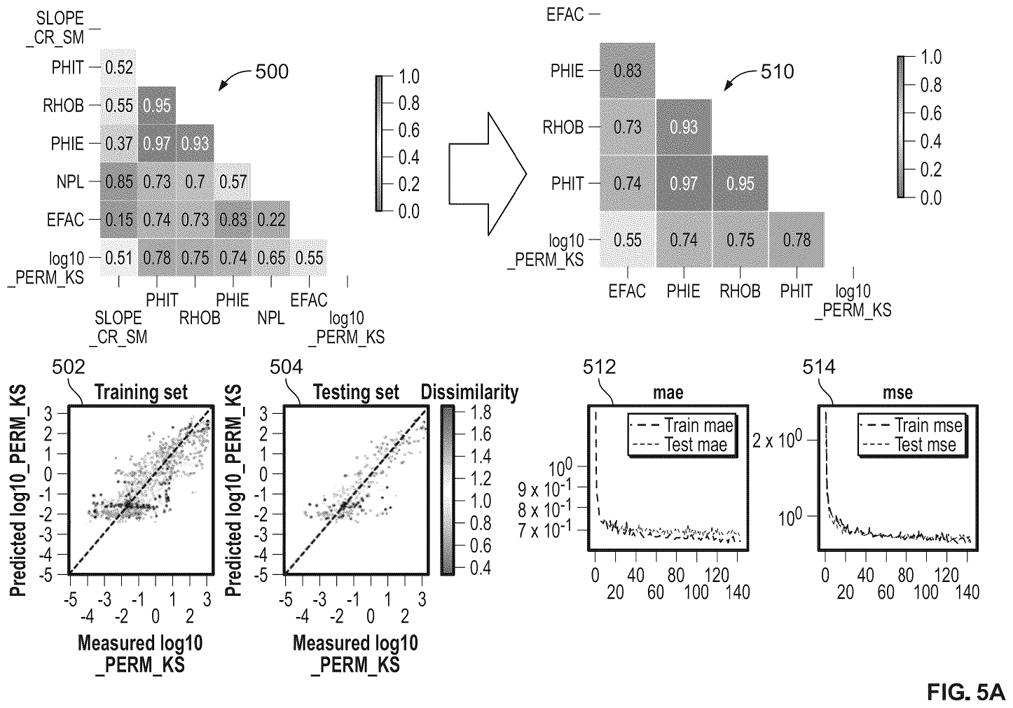

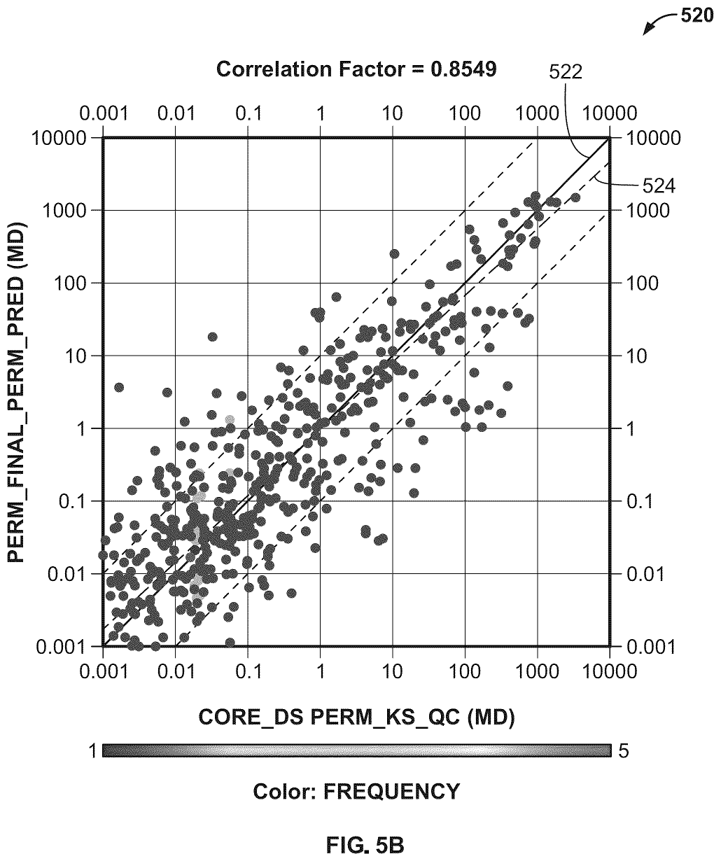

FIG. 5A illustrates the process of selecting the best log predictors. Correlation matrix 500 shows correlations of permeability with each log initially included in the input data. The cross plot for the training set 502 shows measured permeability (X) versus predicted permeability (Y). The cross plot for the testing set 504 shows measured permeability (X) versus predicted permeability (Y). Correlation matrix 510 shows the correlation results of running the model after removing the Slope_CR_SM and NPL logs. Plot 512 shows mean average error and plot 514 shows mean squared error. Plots 512 and 514 show error values through the maximum number of iterations ran for both data test and training data sets. As the log predictors are down selected based on correlation factor, the error is reduced. Error is further reduced through more refinement iterations of the model.

FIG. 5B shows a cross plot of measured permeability on the X axis versus predicted permeability on the Y axis with data from both example implementations plotted in the scatter. Line 522 shows the perfect correlation line. Line 524 shows the best fit line to the scatter data. The correlation factor is 85%. The impact of the permeability prediction on the water saturation height function is validated by comparing the difference in the bulk volume from logs against SHF MICP based measurements.

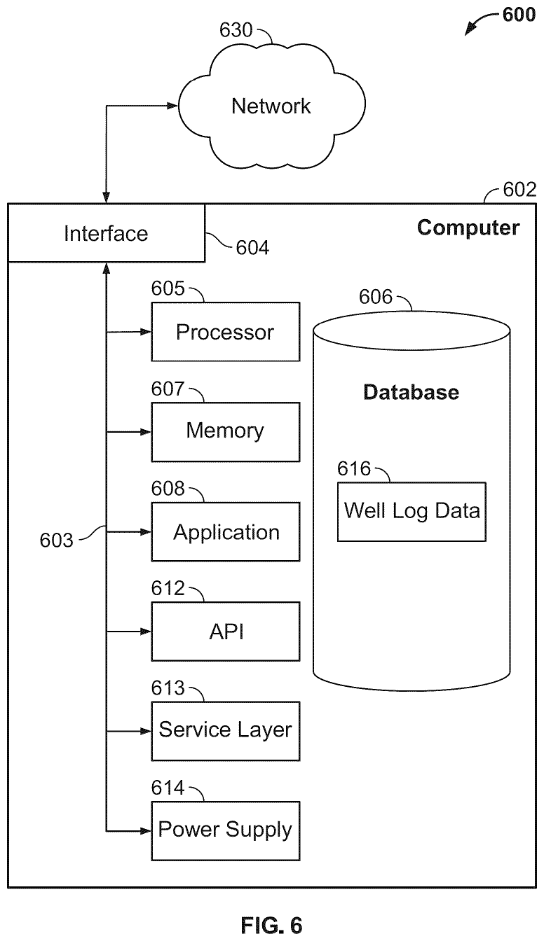

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the hardware of the interface can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data (for example, well log data 616) for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the scope of this disclosure. Accordingly, other embodiments are within the scope of the following claims.

What is claimed is:

1. A method for petrophysical modeling of a subterranean reservoir, the method comprising:
generating a first distribution of values representing a fluid volume and a second distribution of values representing a mineral volume of the subterranean formation, the generating being based on a probabilistic mineralogical evaluation;
determining a third distribution of values representing a volume of silt distribution in the subterranean formation; and
generating a model specifying a predicted permeability distribution for the subterranean formation, the model being based on the first distribution of values representing the fluid volume, the second distribution of values representing the mineral volume, and the third distribution of values representing the volume of silt.

2. The method of claim 1, further comprising:
defining, based on the model, distinct petrophysical rock types for the subterranean formation.

3. The method of claim 2, further comprising:
generating, based on the predicted permeability distribution and the defined petrophysical rock types, a saturation height function model specifying the saturation of fluids in the subterranean formation.

4. The method of claim 3, further comprising:
estimating, based on the predicted permeability distribution, the defined petrophysical rock types and the saturation height function model, hydrocarbon reserves in the subterranean formation.

5. The method of claim 1, wherein determining the volume of silt distribution comprises processing data from Thomas Stieber plots and a deterministic shaly silt sand model.

6. The method of claim 1, wherein generating a model specifying a predicted permeability comprises clustering values from a set of log predictors.

7. The method of claim 6, wherein clustering values comprises a machine learning model clustering values from a set of log predictors.

8. The method of claim 1, further comprising:
classifying, based on the model, electrofacies of the subterranean formation, wherein classes of electrofacies correspond with ranges of predicted permeability.

9. The method of claim 1, further comprising:
controlling production of hydrocarbons from the subterranean formation based on the predicted permeability.

10. The method of claim 1, further comprising:
validating the predicted permeability distribution based on comparing the predicted permeability to measured core data.

11. The method of claim 1, wherein the probabilistic mineralogical evaluation comprises
generating forward modeled distributions of values representing fluid and mineral volumes;
generating a set of logs based on the forward modeled distributions representative of measured well logs; and
refining the forward modeled distributions by minimizing an error between the generated set of logs and the measured well logs.

12. One or more non-transitory machine-readable storage devices storing instructions for petrophysical modeling of a subterranean reservoir, the instructions being executable by one or more processing devices to cause performance of operations comprising:
generating a first distribution of values representing a fluid volume and a second distribution of values representing a mineral volume of the subterranean formation, the generating being based on a probabilistic mineralogical evaluation;
determining a third distribution of values representing a volume of silt distribution in the subterranean formation; and
generating a model specifying a predicted permeability distribution for the subterranean formation, the model being based on the first distribution of values representing the fluid volume, the second distribution of values representing the mineral volume, and the third distribution of values representing the volume of silt.

13. The non-transitory machine-readable storage devices of claim 12, further comprising:
defining, based on the model, distinct petrophysical rock types for the subterranean formation.

14. The non-transitory machine-readable storage devices of claim 13, further comprising:
generating, based on the predicted permeability distribution and the defined petrophysical rock types, a saturation height function model specifying the saturation of fluids in the subterranean formation.

15. The non-transitory machine-readable storage devices of claim 14, further comprising:
estimating, based on the predicted permeability distribution, the defined petrophysical rock types and the saturation height function model, hydrocarbon reserves in the subterranean formation.

16. The non-transitory machine-readable storage devices of claim 12, wherein generating a model specifying a predicted permeability comprises a machine learning model clustering values from a set of log predictors.

17. A system for petrophysical modeling of a subterranean formation, the system comprising:
at least one processor; and
a memory storing instructions that, when executed by the at least one processor, cause the at least one processor to perform operations comprising:
generating a first distribution of values representing a fluid volume and a second distribution of values representing a mineral volume of the subterranean formation, the generating being based on a probabilistic mineralogical evaluation;
determining a third distribution of values representing a volume of silt distribution in the subterranean formation; and
generating a model specifying a predicted permeability distribution for the subterranean formation, the model being based on the first distribution of values representing the fluid volume, the second distribution of values representing the mineral volume, and the third distribution of values representing the volume of silt.

18. The system of claim 17, further comprising:
defining, based on the model, distinct petrophysical rock types for the subterranean formation.

19. The system of claim 18, further comprising:
generating, based on the predicted permeability distribution and the defined petrophysical rock types, a saturation height function model specifying the saturation of fluids in the subterranean formation.

20. The system of claim 17, wherein generating a model specifying a predicted permeability comprises a machine learning model clustering values from a set of log predictors.
